(19) United States
(12) Patent Application Publication
(10) Pub. No.: US 2024/0131752 A1
(43) Pub. Date: Apr. 25, 2024

(54) METHOD FOR TREATING COMPLEX SHEETS

(71) Applicant: Daniel RIERA I BOIX, Campins (ES)

(72) Inventor: Daniel RIERA I BOIX, Campins (ES)

(21) Appl. No.: 18/548,326

(22) PCT Filed: Mar. 3, 2022
(86) PCT No.: PCT/ES2022/070119

§ 371 Date: Aug. 28, 2023

(30) Foreign Application Priority Data
Mar. 4, 2021 (ES) P202130190

(51) Int. Cl. B29B 17/02; B29B 17/04

(52) U.S. Cl. CPC B29B 17/02; B29B 17/0412; B29B 2017/0203; B29B 2017/0296

(57) ABSTRACT

Method of treating complex films, comprising at least a first single sheet of a polymer, preferably PET, a second single sheet of a polymer, preferably PE, and at least one layer of adhesive, preferably EVA or acrylic. The sheets are in flake form and are separated by subjecting them to a first stirring bath in hot water with at least one dicarboxylic acid and at least one fatty acid, preferably oxalic acid and oleic acid; plus a second stirring bath with a caustic agent, preferably caustic soda, and a surfactant. The PE and PET films are separated by at least one densifying bath. The PET films are then treated by means of a stirring bath, a drying silo and a foreign particle separation machine. After each bath, except between the two densifying baths, the flakes are passed through a centrifuge.

### TECHNICAL FIELD

The invention belongs to the field of waste treatment for its reuse and proposes a method for treating complex film in order to innocuously separate their components.

### BACKGROUND TO THE INVENTION

Sheets made of polymers are used as raw materials for the manufacture of packaging of all kinds, especially for the food and pharmaceutical industries. The most commonly used polymer in packaging is polyethylene terephthalate (PET).

Fresh produce packs are usually made from complex sheets of PET plus another polymer, usually polyolefins, e.g., polyethylene (PE). The reason for this is that a package made from PET film alone is unsuitable for sealing with a transparent film (requiring long sealing times and high sealing temperatures), which is how these packages are usually presented to the public.

The PET and PE sheets are bonded together by an adhesive, most commonly ethylene vinyl acetate (EVA) or acrylic adhesive, although polyurethane is also used. A layer of ethyl vinyl alcohol (EVOH) may be placed on top of the adhesive to improve the gas barrier properties of PET. In some cases, a second layer of adhesive is placed on top of the EVOH layer. The sheets thus formed are referred to as PET/PE or PET/EVOH/PE.

The manufacture of packaging from polymer films produces offcuts of leftover material, which should be recycled. Used packaging can also be recycled. As plastics, recycling involves melting the material. The recycling of complex PET/PE or PET/EVOH/PE foils is problematic, because the melting of different materials results in a cloudy product, which cannot be reused for the production of transparent recycled packaging, but only coloured packaging. However, as coloured containers are less in demand, they have to be sold at a lower price and cannot be recycled indefinitely, because a PE film will have to be bonded to the simple sheet of recycled complex film, resulting in a progressive weakening of the resulting complex film. These problems are leading to surplus used PET/PE that cannot be recycled.

Because of the aforementioned problems, it is desirable to recycle PET/PE or PET/EVOH/PE packaging by first separating its constituent single sheets, so that the resulting recycled polymers can subsequently be used to make other recycled complex sheets with the same properties as the virgin raw material, e.g., they can be used to produce transparent packaging. However, the separation of the single sheets forming a complex film presents technical problems, due to the presence of the adhesive.

Various techniques have been described in the prior art for the processing of complex films comprising the separation of their various components. In EP2650324B1 (LINPAC PACKAGING LIMITED), 16 Oct. 2013, “Process recycling of plastic products” the first material is physically separated by shearing and application of heat, preferably between 80° and 100°.

ES2211345 (NEOPLÁSTICA ESPAÑA, S.A.), Jan. 7, 2004, “Procedimiento para la separación de polietilentereftalato a partir de láminas multicapa” [Procedure for the separation of polyethylene terephthalate from multilayer films] describes a method consisting of bringing the film into contact with a medium comprising water and an alcohol. ES2398079 (SULAYR GLOBAL SERVICE, S.L.), 13 Mar. 2013, “Procedimiento para la obtención de RPET (polietilentereftalato recuperado) a partir de láminas complejas adhesivas con poliuretanos” [Procedure for obtaining RPET (recovered polyethylene terephthalate) from polyurethane adhesive complex films] uses alkaline bleach as a separating agent.

The invention that is the subject of this patent proposes a method for breaking up complex films by separating their constituent elements through successive baths in water with agents that are harmless in that they do not give rise to unpleasant odours in the resulting product.

### EXPLANATION OF THE INVENTION

The invention relates to a method of processing complex foils as defined in claim 1. Other embodiments are defined in the dependent claims.

The starting material for the realisation of the method are complex films, typically from waste from the extrusion and thermoforming industries, as well as post-consumer packaging.

Complex films are understood to be films composed of multiple single films, comprising at least one film of a first polymer and one film of a second polymer. The complex film comprises at least one layer of adhesive. Preferably, the first polymer is polyethylene terephthalate (PET), the second polymer is polyethylene (PE) and the adhesive is of acrylic type, more preferably ethylene vinyl acetate (EVA).

The purpose of the invention is to recover the single sheets constituting the complex sheet, eliminating the remains of adhesive and other elements (EVOH, plastic particles of other colours, remains of metal), so that they can be reincorporated into the production lines as recycled materials.

The complex flakes must be shredded into small particle sizes (called flakes). Grinding of manufacturing trimmings and post-consumer packaging into flakes is a common step in recycling operations.

Once the crushed complex sheets are ready, the method is developed in three stages, known in the state of the art: breaking up of the sheets, physical separation and subsequent treatment of the single sheets obtained.

The first stage, or breaking stage, is the most relevant, as it is that which presents the greatest technical difficulties. By carrying out this stage, one goes from having complex films consisting of at least two layers of polymer adhered to each other, to having single films of one or the other polymer. The method of treatment of complex films proposed by the present invention is essentially characterised in that the agents for breaking down the complex films are at least one acidic agent and at least one caustic agent. In a preferred embodiment, the acidic agent is a compound of at least one dicarboxylic acid (HOOC—R—COOH) and at least one fatty acid (R—COOH). In a more preferred embodiment, the at least one dicarboxylic acid is oxalic acid (HOOC—COOH) and the at least one fatty acid is oleic acid (C18H34O2). In a preferred embodiment, the at least one caustic agent is selected from the group consisting of caustic soda (NaOH) and caustic potash (KHO).

The complex sheet rupture stage comprises the sub-steps of:
Subject the complex films to an initial shaking bath in a container of hot water containing a solution of at least one dicarboxylic acid, preferably oxalic acid and at least one fatty acid, preferably oleic acid.
Passing the sheets through mechanical means of reducing the liquid content, by which is meant any mechanical means by which the liquid in which the sheets are impregnated after having been immersed in water can be substantially removed. Preferably such means are a centrifuge.
The sheets are subjected to a second shaker bath in a hot water tank with a caustic agent selected from caustic soda and caustic potash. In a more preferred embodiment, a surfactant is added to this second shaker bath.

With the above operations, the material has been broken up. The next stage is the physical separation of the resulting single sheets, which involves subjecting them to at least one densifying bath, after which the flakes of the two polymers can be extracted separately.

From here on, the flakes of on and the other polymer will be treated separately, focusing the method, in the proposed embodiment, on the treatment of PET flakes, which have a higher commercial value and high regulatory requirements for their recovery.

### BRIEF DESCRIPTION OF THE FIGURES

The description is supplemented by a drawing which is illustrative and non-limiting in nature and depicts the following:

FIG. 1.—Sequence of operations for the treatment of complex laminates.

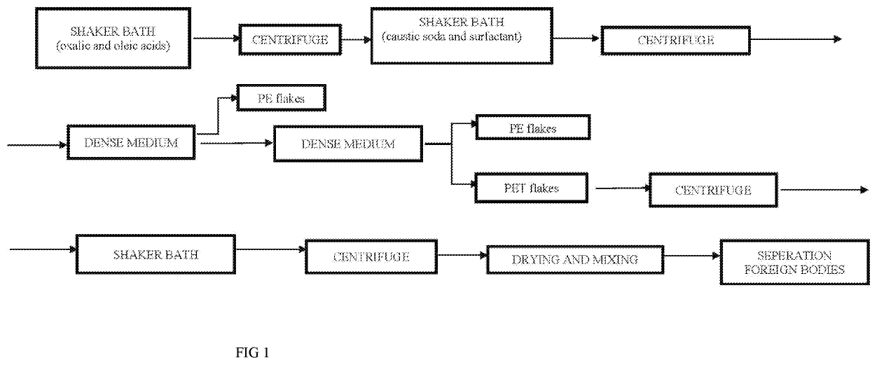

### PREFERRED EMBODIMENT OF THE INVENTION

In a preferred embodiment, the complex films used in the method consist of a polyethylene terephthalate (PET) film and a polyethylene (PE) layer, bonded with ethylene vinyl acetate (EVA) or an acrylic adhesive. An ethyl vinyl alcohol (EVOH) layer may have been applied between the adhesive and the PE layer, or an additional layer of adhesive may have been applied between the adhesive and the PE layer, without affecting the method and the results obtained.

The complex films to be treated are in the form of flakes, with an approximate size of 12 to 15 millimetres. In this example, a quantity of approximately 600 kilograms of these flakes is treated.

In a first stage, the flakes are broken up. For this purpose, a vessel with a means, known in the art, of shaking is used, which normally consists of a conical cylindrical metal tank inside which, in the part corresponding to the conical apex, propellers are arranged.

For the indicated amount of flakes, the tank is filled with approximately 2.5 m3 of water at a temperature between 80° and 90°. Oxalic acid and oleic acid are added to the water. The oxalic acid is administered already dissolved in water, preferably in a 10% solution. Solutions of oxalic acid are commercially available. In one embodiment, between 12.5 and 37.5 litres of 10% solution are administered, resulting in a concentration of between 500 ppm and 1500 ppm oxalic acid in the water tank. In a more preferred embodiment, 25 litres of 10% solution, i.e., a concentration of 1000 ppm oxalic acid is administered into the water tank. In one embodiment, 2.5 to 7.5 litres of oleic acid (1000-3000 ppm in the water tank) are added. In a more preferred embodiment, the dose of oleic acid is 5 litres, i.e. at a concentration of 2000 ppm in the water tank.

The 600 kg of flakes are immersed in the tank and subjected to a shaker bath for approximately thirty minutes.

When the bath is finished, the flakes are removed from the tank and introduced into a means of reducing the liquid element, preferably a horizontal centrifugal machine of the kind existing in the state of the art, in which the material is fed in at one end and then comes out at the other end. In these machines, the flakes will never come out completely dry, but with a moisture content of about 1.5%.

The flakes are then taken to a second bath in another shaker tank with the same characteristics as the one described above and with the same volume of approximately 2.5 m3 of water, in this case at a temperature between 70° and 95°. A caustic agent selected from the group consisting of caustic soda and caustic potash is dissolved in the water, in both cases with a concentration of between 1% and 5%, and most preferably 2%.

In a preferred embodiment, a surfactant, commonly used for washing PET bottles, is also added to the aforementioned breaking agent. The approximate dosage of the surfactant is 1 ml per litre of water (1000 ppm). This second shaking bath lasts approximately 30 minutes.

The mechanical friction inside the shaker tank, and the breaking agents used, will result in that, where there was a mass of complex PET and PE sheets, there is now a mass of single PET and PE sheets mixed inside the tank.

The next step is the physical separation of the PET and PE flakes inside the tank where they have been subjected to the second shaker bath. For this purpose, the combined mass of flakes is extracted and returned to the centrifuge.

Subsequently, they are subjected to a first densification bath, after which the PE flakes, which will have remained floating on the surface of the water, will be removed. However, PE flakes will remain on the bottom, mixed with the PET flakes, so a second densification bath will be applied, which will ensure that the remaining PE flakes on the bottom of the tank rise to the surface, after which they can be removed, and the PET flakes can be collected.

From this point on, the flakes of one material and the other will be treated separately.

As for the PE flakes, they are accumulated and when an amount considered sufficient is achieved, they are dried and agglomerated. This is the end of the treatment of the flakes of this material.

The remaining steps of the method are directed to the treatment of the PET flakes, which is carried out according to the following sub-steps:
The PET flakes, which are wet after the densification baths, are fed into the centrifuge.
They are subjected to a shaker bath in clean cold water, from which the material will be free of any chemical residues. The pH of the flakes after this bath shall be approximately 7-8.
The flakes are passed through a centrifuge again.
They are loaded into a container with means of mixing and drying, e.g., a mixing and drying silo known in the state of the art. The moisture content of the flakes after this treatment should be below 1%, preferably below 0.7%.
Once removed from the silo, they are subjected to a particle separating device known in the state of the art. Depending on the type of separator used, foreign particles such as coloured particles, metals or plastics other than PET can be separated.

1. A method of treating complex films, comprising at least a first single film of a polymer, a second single film of a polymer and at least one layer of adhesive, the method comprising:
breaking up the complex films,
separating the single films; and
further treating at least one of the at least two single films,
wherein the agents for breaking up the complex films are at least one acidic agent and at least one caustic agent.

2. The method of treating complex films according to claim 1, wherein the at least one acidic agent is a compound of at least one dicarboxylic acid (HOOC—R—COOH) and at least one fatty acid.

3. The method of treating complex films according to claim 2, wherein the at least one dicarboxylic acid (HOOC—R—COOH) is oxalic acid and the at least one fatty acid (R—COOH) is oleic acid (C18H34O2).

4. The method of treating complex films according to claim 1, wherein the at least one caustic agent is selected from the group consisting of caustic soda (NaOH) and caustic potash (KHO).

5. The method of treating complex foils according to claim 1, wherein the breaking stage comprises:
subjecting the flakes to a stirring bath in hot water and a solution of at least one acidic agent;
subjecting the complex foils to means of reducing the liquid element; and
subjecting them to a second stirring bath in hot water and a solution of at least one caustic agent.

6. The method of treating complex films according to claim 5, wherein the solution of at least one acidic agent comprises at least one dicarboxylic acid (HOOC—R—COOH) and at least one fatty acid (R—COOH).

7. The method of treatment of complex films according to claim 5, wherein a surfactant is also added to the second shaker bath.

8. The method of processing complex sheets according to claim 1 wherein the separation stage comprises:
subjecting the complex sheets to liquid element reduction means;
subjecting them to at least one densifying bath; and
separately extracting the resulting single sheets.

9. The method of processing complex films according to claim 1, wherein the first film of the complex film is made of polyethylene terephthalate (PET) and the second film is made of polyethylene (PE).

10. The method of treating complex films according to claim 1, wherein the at least one single film that undergoes further treatment is the polyethylene terephthalate (PET) film.

11. The method of treatment of complex films according to claim 10, wherein the stage of further treatment of polyethylene terephthalate (PET) films comprises:
subjecting the films to a shaker bath in water; and
placing them in a container with mixing and drying means.

12. The method of treatment of complex films according to claim 11 wherein before and after subjecting the PET films to the shaker bath in water, means of reducing the liquid element present in the films are applied to them.

13. The method of processing complex films according to claim 11, wherein after depositing the PET films in the container with mixing and drying means, they are passed through a foreign particle detection device.
